(19) United States
(12) Patent Application Publication
(10) Pub. No.: US 2011/0091725 A1
(43) Pub. Date: Apr. 21, 2011

(54) Integral Anti-Rattle Feature for Cables

(75) Inventor: Joseph P. Fannon, Washington, MI (US)

(73) Assignee: GM GLOBAL TECHNOLOGY OPERATIONS, INC., Detroit, MI (US)

(21) Appl. No.: 12/579,476

(22) Filed: Oct. 15, 2009

(51) Int. Cl. B32B 1/00; B05D 7/00

(52) U.S. Cl. 428/375; 427/209

(57) ABSTRACT

A cable having an anti-rattle feature which is integrally formed of the cable casing at the time of forming of the cable casing. The integrated cable casing with anti-rattle feature is composed of a cable casing and a plurality of longitudinal fins radially emanating therefrom, wherein the cable casing and the longitudinal fins are formed simultaneously. According to a method of manufacture of the integrated cable casing with anti-rattle feature, a plastic forming apparatus includes an extrusion opening configured to simultaneously extrude the cable casing with the longitudinal fins.

### TECHNICAL FIELD

The present invention relates to cables, and more particularly to cables with anti-rattle features which are secondarily attached thereto. More particularly, the present invention is related to a cable having an anti-rattle feature integrated into the cable casing, itself.

### BACKGROUND OF THE INVENTION

Cables used in motor vehicles for operation of, for example, latch mechanisms, are generally composed of a core concentrically disposed with respect to a cable casing, wherein the cable casing is retained in a stationary disposition as the core is slidingly moved with respect to the cable casing in order to effect a selected operation of the latch mechanism from a remote actuation site. The cable may have, at various locations therealong, close proximity to vehicular surfaces, and in the event, for example, the motor vehicle traverses a rough road, the cable may vibrate against these proximate surfaces and thereby produce a rattle or other unwanted noise. Accordingly, special provisions are necessary to prevent cables from producing rattles or making otherwise unwanted noises due to vibration under various driving and vehicle use conditions. The current automotive industry practice in most cases is to add an external anti-rattle feature in the form of rubber, plastic, or foam sleeves to the cable in order to isolate it from the surrounding surfaces or to at least dampen the sounds of contact. These anti-rattle sleeves add significant cost to a cable since they are applied to the cable in labor intensive secondary operations using special equipment, tools and fixtures.

Anti-rattle sleeves are essential in most motor vehicle cable applications due to the inherently tight packaging environments in which they are used. However, because of the costs, tools, time and labor to install them on cables, anti-rattle sleeves are added to cables judiciously in order to minimize these disadvantages. A single cable, therefore, may have three or more separate anti-rattle sleeves added thereto in order to address only those places where contact to other surfaces is likely to occur (i.e., where rattling may occur) in a specific motor vehicle configuration. Depending on the production process, these strategically placed anti-rattle sleeves may require a locating device, such as adhesive tape, to position them on the cable casing. These anti-rattle sleeve customized cables add to the expense of the cable, and cause the proliferation of many cable part numbers.

FIGS. 1A through 1C depict an example of a cable 10 with one or more prior art anti-rattle sleeves 12, wherein while FIG. 1A shows a first anti-rattle sleeve 12a and a second anti-rattle sleeve 12b, there may be any number thereof. The anti-rattle sleeves 12 are located on the outside of the cable casing 14 as a separate piece from the cable casing, being provided after manufacture of the cable 10, itself. Each anti-rattle sleeve 12 is in the form of an annular sleeve member 16 and a plurality of longitudinal fins 18 which radially emanate therefrom (see FIGS. 1B and 1C), wherein this form of anti-rattle sleeve is commonly referred to as a “star” sleeve. The sleeve member 16 is sized to be slidingly placed onto the cable 10 via slipping over a free end thereof. It may be necessary to add adhesive tape 20 adjacent one end or both ends of the anti-rattle sleeve 12, wherein the tape sticks to the cable casing 14 in order to ensure proper placement of the anti-rattle sleeve on the cable casing. Further, it is generally the practice in the prior art that where a retainer clip 22 is to be attached to the cable casing 14, then at that location there is an absence of the anti-rattle sleeve, as for example depicted at FIG. 1A in the space between the first and second anti-rattle sleeves 12a, 12b.

FIG. 1A shows the cable 10 in operation. In this regard, an end fitting 24a is attached to one end of the cable 10, and at the other end of the cable is attached another end fitting 24b which is attached a latch mechanism 26. By way of non-limiting example, the structural aspects of the cable 10 are depicted at FIGS. 1B and 1C. A core 28 of wire strands is centrally disposed with respect to a plastic conduit liner 30 which provides a sliding interface for the core (the conduit liner is non-slidably interfaced with respect to the cable casing). An optional wire wrap 32, as for example steel coil may be provided over the conduit liner 30, as shown at FIG. 1B. The plastic cable casing 14 is extruded over the wire wrap 32, if present, or over the conduit liner 30 if not present. Where the wire wrap is not present, it is common to provide a plurality of lay wire strands 34 running longitudinally within the cable casing, as shown at FIG. 1C.

As an alternative, the sleeve member 16 may have a slit 16a (see exemplary dashed lines of FIG. 1B) which enables the sleeve to be longitudinally split open so as to fit around the cable casing 14. And, the anti-rattle sleeve may take other forms, as for example the aforementioned “star” sleeve being blow molded over the cable casing 14 of a previously manufactured cable 10, or the anti-rattle sleeve may be composed of a resilient material, such as for example sections of foam wrap placed over the cable casing 14.

In an effort to reduce the aforementioned disadvantages of anti-rattle sleeves, some “solutions” have been used. For example, foam adhesive tape can be used at selected locations of the cable casing, but this also adds time and expensive labor to the vehicle manufacturing process, and introduces the potential for quality problems should there be present poor tape adhesion. For another example, cable clips or stand-offs that retain the cable anchored into an adjacent vehicle surface can be used, but to be effective anti-rattle features, these clips need to be spaced close together which requires significantly more assembly labor to install, and these clips still require a locating device, such as adhesive tape, to definitely locate them on the cable casing so that they can each be installed in the proper fixing point on the vehicle; as such, clips are not often used as anti-rattle features.

Accordingly, what remains needed in the art is an anti-rattle sleeve which has none of the disadvantages of anti-rattle sleeves as are presently known.

### SUMMARY OF THE INVENTION

The present invention is a cable having an anti-rattle feature which is integrally formed of the cable casing at the time of forming of the cable casing.

The integrated cable casing with anti-rattle feature according to the present invention is composed of a cable casing and a plurality of longitudinal fins radially emanating therefrom, wherein the cable casing and the longitudinal fins are formed integrally together. Preferably, the longitudinal fins extend the entire longitudinal length of the cable casing, wherein the fins may be selectively removed at the ends of the cable casing for component assembly and installation particulars.

According to a method of manufacture of the integrated cable casing with anti-rattle feature, a plastic forming apparatus includes an extrusion opening configured to simultaneously extrude the cable casing with the longitudinal fins.

By incorporating the longitudinal fins along the entire length of the cable casing, anti-rattle protection is provided everywhere along the cable, eliminating the need for anti-rattle sleeves and/or other locating devices, and minimizing the need for unique motor vehicle specific cable configurations. Furthermore, in that the functional performance of a cable is largely determined by its ability to resist compression under load, by integrating the longitudinal fins with the entire length of the cable casing, the present invention provides improved compression strength to the cable, thus enabling potential for use of a smaller diameter and/or less expensive cable construction in particular applications.

Accordingly, it is an object of the present invention to provide an integrated cable casing with anti-rattle feature, wherein the cable casing and the anti-rattle feature are formed simultaneously in a single operation.

This and additional objects, features and advantages of the present invention will become clearer from the following specification of a preferred embodiment.

### BRIEF DESCRIPTION OF THE DRAWINGS

FIG. 1A is a side view of a cable shown provided with a pair of prior art anti-rattle “star” sleeves of the prior art.

FIG. 1B is a perspective, partly sectional view of a cable with prior art anti-rattle “star” sleeve of the prior art, wherein the cable includes a wire wrap.

FIG. 1C is a sectional end view of a cable with prior art anti-rattle “star” sleeve of the prior art, wherein the cable includes a plurality of lay wire strands.

FIG. 2 is a side view of a cable having an integrated cable casing with anti-rattle feature according to the present invention.

FIG. 3 is a perspective, partly sectional view of a cable having integrated cable casing with anti-rattle feature according to the present invention, wherein the cable includes a wire wrap.

FIG. 4 is a sectional end view of a cable having integrated cable casing with anti-rattle feature according to the present invention, wherein the cable includes a plurality of lay wire strands.

FIG. 5 is a side perspective view of a cable having an integrated cable casing with anti-rattle feature according to the present invention, including an engirding retainer clip as seen at circle 5 of FIG. 2.

FIG. 6A is a schematic side view of a plastic forming apparatus for the cable having an integrated cable casing with anti-rattle feature according to a method of manufacturing used by the present invention.

FIG. 6B is a front view of the plastic forming apparatus for the cable having an integrated cable casing with anti-rattle feature, seen along line 6B-6B of FIG. 6A.

### DESCRIPTION OF THE PREFERRED EMBODIMENT

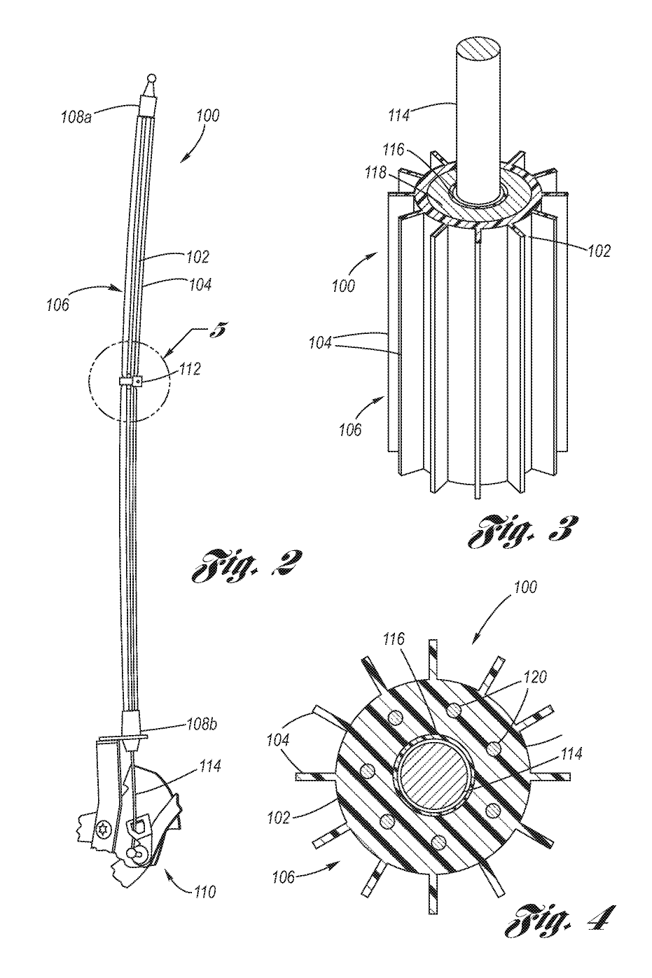

Referring now to the Drawing, FIGS. 2 through 6B depict various aspects of a cable having an integrated cable casing with anti-rattle feature 100 according to the present invention.

The integrated cable casing with anti-rattle feature 100 includes a cable casing 102 and a plurality of longitudinal fins 104 which radially emanate from the cable casing as an integrated single piece therewith, wherein the longitudinal fins provide an integrated anti-rattle feature 106 as a single piece with respect to the cable casing.

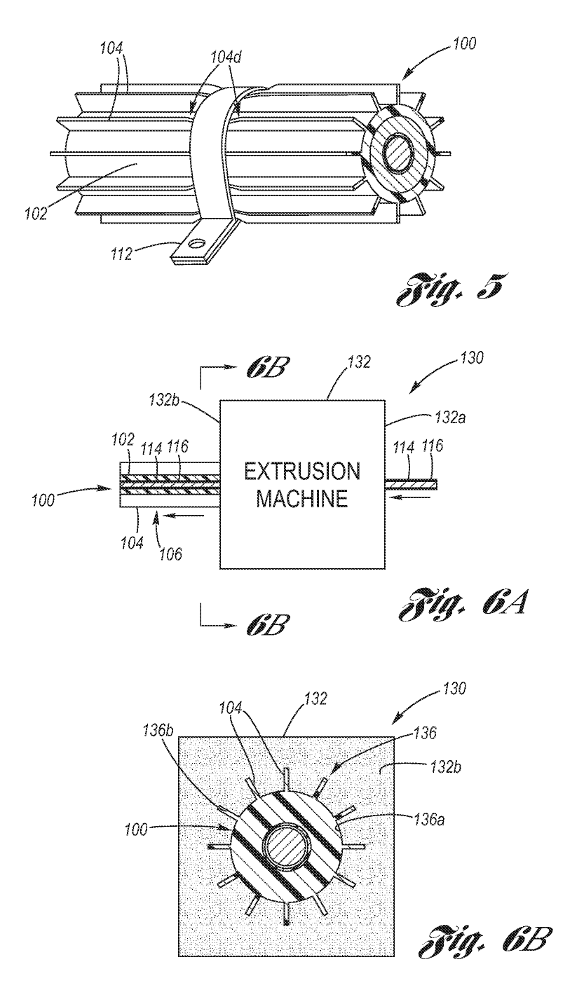

FIG. 2 shows an example of operation of the integrated cable casing with anti-rattle feature 100. An end fitting 108a is attached to one end of the cable 100, and at the other end of the cable is attached another end fitting 108b, which is shown attached a latch mechanism 110. A retainer clip 112 is shown, by way of example, attached to the cable 100 in a manner to be described hereinbelow with respect to FIG. 5.

By way of non-limiting example, the structural aspects of the integrated cable casing with anti-rattle feature 100 are depicted at FIGS. 3 and 4.

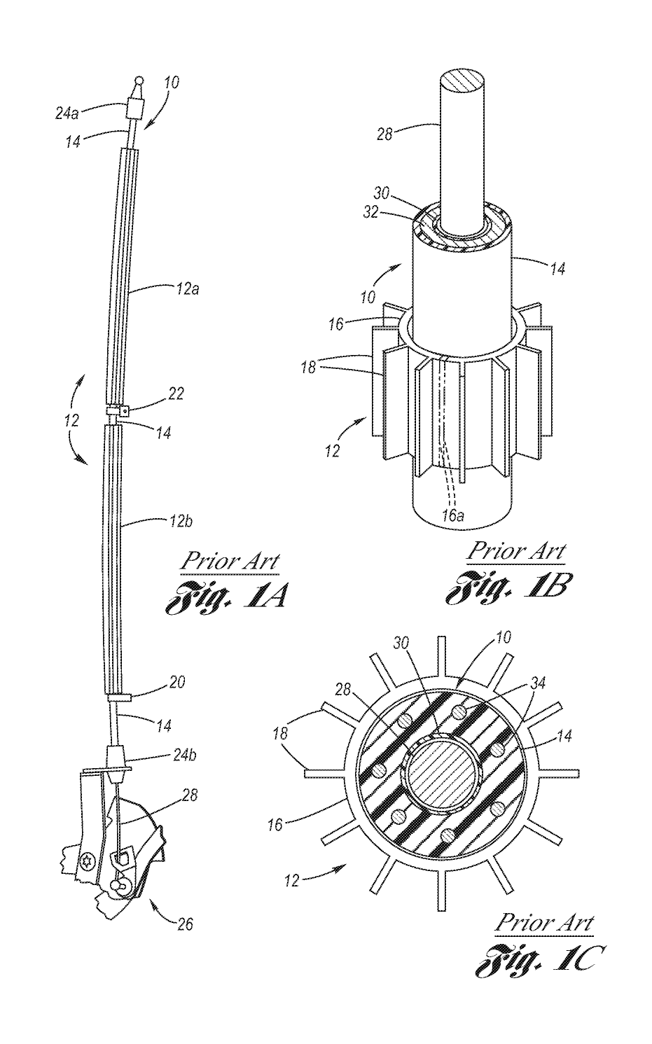

A core 114 of wire strands is centrally disposed with respect to a plastic conduit liner 116 which provides a sliding interface for the core, the conduit liner being non-slidably interfaced with respect to the cable casing 102, wherein the core and conduit liner are conventional, as described with respect to FIGS. 1B and 1C hereinabove. An optional wire wrap 118, as for example steel coil, may be provided over the conduit liner 116, as shown at FIG. 3, which is also conventional, as described hereinabove with respect to FIG. 1B.

The cable casing 102 is integrally formed of the same plastic material as is the longitudinal fins 104, being a single piece plastic extrusion over the wire wrap 118, if present, or over the conduit liner 116, if not present. Where the wire wrap is not present, it is common to provide a plurality of lay wire strands 120 running longitudinally within the cable casing, as shown at FIG. 1C (again, the wire strands are conventional, as for example described hereinabove with respect to FIG. 1C).

It is preferred for the longitudinal fins 104 to extend continuously along the entire longitudinal length of the cable casing 102. In order for the end fittings 108a, 108b to be added to the cable 100, a predetermined section of the core 114 is exposed, and a portion of the longitudinal fins 104 are removed from the cable casing 102 so that the end fitting may fit thereover and then be bonded thereto, as per installation particulars.

As shown at FIG. 5, in order to eliminate the need to strip off a portion of the longitudinal fins 104 where a retainer clip 112 may be disposed, it is preferred to have the retainer clip engird the longitudinal fins and then be contracted so as to crush radially inward upon the longitudinal fins. This provides vibration isolation as between the cable 100 and the retainer clip 112, as well as definite location of the retainer clip on the cable, as the retainer clip cannot creep along the cable due to the crushed portion 104d of the longitudinal fins.

FIGS. 6A and 6b depict a schematic plastic forming apparatus in the preferred form of an extrusion apparatus 130 for carrying out a preferred method of manufacture of the integrated cable casing with anti-rattle feature 100.

The extrusion apparatus 130 includes an extrusion machine 132 which delivers plastic material and heats it, while a drawing mechanism (not shown) passes through the extrusion machine the core 114 with covering conduit liner 116, and, if present, the above mentioned wire wrap 118. If the wire wrap is not present and the lay wire strands 120 are used, then the extrusion apparatus 130 further includes a mechanism to feed the wire strands in unison with the feed of the core 114 and its conduit liner 114.

As can be seen at FIG. 6A, whatever the initial cable configuration 134 before the casing with elongated fins is provided thereto, the initial cable configuration 134 enters the extrusion machine 132 at an entry end 132a thereof and exits and an exit end 132b thereof as the integrated cable casing with anti-rattle feature 100.

As can be seen at FIG. 6B, the exit end 132b of the extrusion machine 132 has an extrusion opening 136 having a cylindrical periphery 136a which corresponds to the shape of the casing 102, as well as radial slots 136b which communicate with the cylindrical periphery, and correspond to the elongated fins 104.

To those skilled in the art to which this invention appertains, the above described preferred embodiment may be subject to change or modification. For example, the term “cable” can refer to cables other than those used for actuating mechanisms, as for example electrical cables. Such change or modification can be carried out without departing from the scope of the invention, which is intended to be limited only by the scope of the appended claims.

1. A cable, comprising:
a cable casing; and
an anti-rattle feature emanating radially from said cable casing;
wherein said cable casing and said anti-rattle feature are integrally formed as a single piece of the same plastic material.

2. The cable of claim 1, wherein said anti-rattle feature comprises a plurality of longitudinal fins, each fin emanating radially with respect to said cable casing.

3. The cable of claim 2, wherein said plurality of fins extend substantially entirely along said cable casing.

4. The cable of claim 3, wherein said plurality of elongated fins extend continuously.

5. The cable of claim 4, further comprising a retainer clip engirding said elongated fins, wherein said retainer clip is adjusted so as to crush radially inward on said elongated fins.

6. A cable, comprising:
a core;
a cable casing surrounding said core; and
an anti-rattle feature emanating radially from said cable casing;
wherein said cable casing and said anti-rattle feature are integrally formed as a single piece of the same plastic material.

7. The cable of claim 6, wherein said anti-rattle feature comprises a plurality of longitudinal fins, each fin emanating radially with respect to said cable casing.

8. The cable of claim 7, wherein said plurality of fins extend substantially entirely along said cable casing.

9. The cable of claim 8, wherein said plurality of elongated fins extend continuously.

10. The cable of claim 9, further comprising a retainer clip engirding said elongated fins, wherein said retainer clip is adjusted so as to crush radially inward on said elongated fins.

11. The cable of claim 9, further comprising a conduit liner disposed between said core and said cable casing, wherein said conduit liner is non-slidable with respect to said cable casing and said core is slidable with respect to said conduit liner.

12. The cable of claim 11, further comprising a retainer clip engirding said elongated fins, wherein said retainer clip is adjusted so as to crush radially inward on said elongated fins.

13. A method of manufacture of a cable comprising:
moving a core through a plastic forming apparatus; and
forming plastic circumferentially over the core as the core moves through the plastic forming apparatus, wherein the formed plastic comprises:
a cable casing; and
an anti-rattle feature emanating radially from said cable casing;
wherein said cable casing and said anti-rattle feature are integrally formed as a single piece of the same plastic material.

14. The method of claim 13, wherein in said step of forming, the anti-rattle feature comprises a plurality of longitudinal fins, each fin emanating radially with respect to said cable casing.

15. The method of claim 14, wherein the plurality of fins are formed continuously and entirely along the cable casing.

16. The method of claim 15, wherein said step of forming is an extrusion process.

17. The method of claim 16, wherein said step of moving comprises moving the core with a conduit liner thereover, wherein said step of forming forms the plastic over the conduit liner as the core and conduit liner move through the plastic forming apparatus.

18. The method of claim 16, wherein said step of moving comprises moving the core with a conduit liner and a wire wrap thereover, wherein said step of forming forms the plastic over the wire wrap as the core, conduit liner and wire wrap move through the plastic forming apparatus.
